(19) United States
(12) Patent Application Publication
(10) Pub. No.: US 2009/0071396 A1
(43) Pub. Date: Mar. 19, 2009

(54) SYSTEM FOR PRODUCTION-LINE PRINTING ON WET WEB MATERIAL

(75) Inventors: Michael Shvartzman, Givat Avn (IL); Yuval BERENSTAIN, Yokneam (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: N.R. SPUNTECH Industries Ltd., Tiberias (IL)

(21) Appl. No.: 12/268,457

(22) Filed: Nov. 11, 2008

Related U.S. Application Data
(62) Division of application No. 10/667,419, filed on Sep. 23, 2003, now abandoned.

(30) Foreign Application Priority Data
Feb. 13, 2003 (IL) 154452

(51) Int. Cl. B05C 13/00; B05C 11/00

(52) U.S. Cl. 118/46; 118/68

(57) ABSTRACT

The present invention is method and system for applying a finish to non-woven fabric as part of the production line, during the production process, and provides for the selective application of, for example, colorants so as to produce patterns or graphic designs to the non-woven fabric before completion of the drying process.

### FIELD AND BACKGROUND OF THE INVENTION

The present invention relates to applying additives to web material during the production of such web material and, in particular, it concerns applying the additive before completing the drying process, while the web material is still wet.

Non-woven web materials are well known and there is a variety of processes by which these web materials are produced. Some examples may be found in U.S. Pat. Nos. 5,403,444, to Goettmann, et al.; 4,623,575, to Brooks, et al.; 5,009,747, to Viazmensky, et al.; and 5,151,320, to Homonoff, et al.

The addition of additives and/or colorants to non-woven web materials has generally been limited to the inclusion of the additives in the initial slurry or application to the finished web material after production, off of the production line. The inclusion of additive in the slurry requires large quantities of additives and an addition cleaning process. Therefore, in practice some of the addition of additives to non-woven web material generally has been carried out by immersing the webs or running lengths of the fabric in an aqueous solution of the desired additive or by applying such solution or emulsion to the surfaces of the non-woven web of fibers by spraying, by patting, by roller or other types of applicator, during a separate process after the web material has been removed from the original production line.

The addition of selectively applied dyed patterns or graphic designs has been generally been limited to conventional dry printing processes carried out on completed non-woven web material. This process entails the additional time consuming procedure of mounting a finished roll of non-woven web material on appropriate printing equipment and passing a length of the web material through the printer system.

Substantially all of the systems of prior art used to apply an additive, coating, pattern or graphic design suffer from several problems. These include batch processing as opposed to the substantially continuous process by which the non-woven web material is produced. Each batch must be run on a separate machine that requires un-winding and feed mechanisms, rollers and tensioning elements, a separate dryer, and a separate re-winding mechanism for the take-up roll. Such systems suffer from numerous problems cause by dust generated by the printing process and heat generated by mechanical parts.

There is therefore a need for method and system for applying additives and/or a finish to non-woven fabric as an in-line part of the production line, during the production process. It would be advantageous if system provided for the selective application of the additives, such as colorants, which may be used to produce patterns or graphic designs, to the non-woven fabric before completion of the drying process.

### SUMMARY OF THE INVENTION

The present invention is method and system for applying additives and/or a finish to non-woven fabric as an in-line part of the production line, during the production process, and provides for the selective application of the additives, such as, but not limited to, colorants, which may be used to produce patterns or graphic designs, to the non-woven fabric before completion of the drying process.

According to the teachings of the present invention there is provided, a method for applying a finishing agent to non-woven fabric during production of the non-woven fabric, the method comprising: (a) substantially continuous forming of a web of non-woven fabric having a moisture content greater than 10%; (b) applying the finishing agent to the non-woven fabric, while the moisture content of the non-woven fabric is greater than 10% by weight; and (c) subsequently drying the non-woven fabric together with the finishing agent.

According to a further teaching of the present invention the applying the finish is an in-line process of the production of the non-woven fabric.

According to a further teaching of the present invention the formation is by a hydro-entanglement process.

According to a further teaching of the present invention the formation is by a wet-laid process.

According to a further teaching of the present invention the formation is by a dry-laid process.

According to a further teaching of the present invention, there is also provided removal of at least a portion of production water from the non-woven fabric prior to the applying.

According to a further teaching of the present invention the removal of at least a portion of production water from the non-woven fabric renders water content of the non-woven fabric in a range of between 80%-150% by weight.

According to a further teaching of the present invention the removal of at least a portion of production water from the non-woven fabric is implemented as dewatering followed by a preliminary drying process, thereby rendering water content of the non-woven fabric in a range of between 10%-80% by weight.

According to a further teaching of the present invention the applying is substantially uninterrupted application along the substantially continuous non-woven fabric.

According to a further teaching of the present invention the applying of the finishing agent is accomplished using a rotary finishing application system.

According to a further teaching of the present invention the rotary finishing application system is implemented as a rotary screen printing system.

According to a further teaching of the present invention the rotary finishing application system is an engraving roll printing system.

According to a further teaching of the present invention the applying of the finishing agent is implemented as applying a paste.

According to a further teaching of the present invention the applying of the finishing agent is implemented as applying a foam.

According to a further teaching of the present invention the applying of the finishing agent includes applying a detergent additive.

According to a further teaching of the present invention the applying of the finishing agent includes applying a scent producing additive.

According to a further teaching of the present invention the applying of the finishing agent includes selective applying a colorant.

According to a further teaching of the present invention the applying of the finishing agent includes selective applying a graphic design.

There is also provided according to the teachings of the present invention a method for applying a finishing agent to non-woven fabric during production of the non-woven fabric, the method comprising: (a) substantially continuous forming of a web of non-woven fabric; and (b) applying the finishing agent to the non-woven fabric as an in-line process in the production.

According to a further teaching of the present invention the formation is by a hydro-entanglement process.

According to a further teaching of the present invention the formation is by a wet-laid process.

According to a further teaching of the present invention the formation is by a dry-laid process.

According to a further teaching of the present invention, there is also provided removing at least a portion of production water from the non-woven fabric.

According to a further teaching of the present invention the removal of at least a portion of production water.

According to a further teaching of the present invention the applying is substantially uninterrupted application along the substantially continuous non-woven fabric.

According to a further teaching of the present invention the applying of the finishing agent is accomplished using a rotary finishing application system.

According to a further teaching of the present invention the rotary finishing application system is implemented as a rotary screen printing system.

According to a further teaching of the present invention the rotary finishing application system is an engraving roll printing system.

According to a further teaching of the present invention the applying of the finishing agent is implemented as applying a paste.

According to a further teaching of the present invention the applying of the finishing agent is implemented as applying a foam.

According to a further teaching of the present invention the applying of the finishing agent includes applying a detergent additive.

According to a further teaching of the present invention the applying of the finishing agent includes applying a scent producing additive.

According to a further teaching of the present invention the applying of the finishing agent includes selectively applying a colorant.

According to a further teaching of the present invention the applying of the finishing agent includes selectively applying a graphic design.

There is also provided according to the teachings of the present invention a system for applying a finishing agent to non-woven fabric during production of the non-woven fabric, the system comprising: (a) a web forming apparatus configured to form a substantially continuous web of non-woven fabric; (b) a finishing apparatus configured to apply the finishing agent to the non-woven web fabric as an in-line process in the production; and (c) at least a first drying apparatus configured to dry the non-woven fabric together with the finishing agent.

According to a further teaching of the present invention the web formation apparatus is a hydro-entanglement apparatus.

According to a further teaching of the present invention the web formation apparatus is a wet-laid web formation apparatus.

According to a further teaching of the present invention the web formation apparatus is a dry-laid web formation apparatus.

According to a further teaching of the present invention, there is also provided a dewatering apparatus configured to remove of at least a portion of production water from the non-woven fabric.

According to a further teaching of the present invention the dewatering apparatus renders water content of the non-woven fabric greater than 10% by weight.

According to a further teaching of the present invention the dewatering apparatus renders water content of the non-woven fabric 80%-150% by weight.

According to a further teaching of the present invention, there is also provided at least a second drying system deployed between the dewatering apparatus and the finishing apparatus.

According to a further teaching of the present invention water content of the non-woven fabric is 10%-80% by weight.

According to a further teaching of the present invention the applying of the finishing agent is substantially uninterrupted along the substantially continuous non-woven fabric.

According to a further teaching of the present invention the finishing apparatus is a rotary finishing application system.

According to a further teaching of the present invention the rotary finishing application system is a rotary screen printing system.

According to a further teaching of the present invention the rotary finishing application system is an engraving roll printing system According to a further teaching of the present invention rotary finishing application system is configured so as to apply a paste.

According to a further teaching of the present invention rotary finishing application system is configured so as to apply a foam.

According to a further teaching of the present invention the finishing agent includes a detergent additive.

According to a further teaching of the present invention the finishing agent includes a scent producing additive.

According to a further teaching of the present invention finishing apparatus is configured so as to selectively apply a colorant.

According to a further teaching of the present invention the colorant is selectively applied as a graphic design.

### BRIEF DESCRIPTION OF THE DRAWINGS

The invention is herein described, by way of example only, with reference to the accompanying drawings, wherein:

FIG. 1 is a block diagram of a first preferred production line operative according to the principles of the present invention;

FIG. 2 is a block diagram of an alternative preferred production line operative according to the principles of the present invention;

FIG. 3 is a schematic representation of a rotary finishing unit configured to apply finishing agent to both sides of the non-woven fabric; and

FIG. 4 is a schematic representation of a rotary finishing unit configured to apply finishing agent to one side of the non-woven fabric

### DESCRIPTION OF THE PREFERRED EMBODIMENTS

The present invention is method and system for applying additives and/or a finish to non-woven fabric as an in-line part of the production line, during the production process, and provides for the selective application of colorants, which may be used to produce patterns or graphic designs, to the non-woven fabric before completion of the drying process.

The principles and operation of in-line production line application of a finish to non-woven fabric according to the present invention may be better understood with reference to the drawings and the accompanying description.

By way of introduction, a principle of the present invention is to introduce the step of applying a finishing agent into the in-line portion the initial production of non-woven fabric, rather than applying the finishing agent during a separate process. The term “non-woven fabric” as used herein refers to either non-woven web material or non-woven fabric at substantially any point in the production process beginning with the web formation and continuing to the completion of the finished fabric. The term “in-line” as used herein refers to the actual production line that produces the non-woven fabric, terminating at the initial take-up roll. Any handling or processing of the non-woven fabric after it is on the initial take-up roll is, for the purposes of the discussion herein, considered to be “off-line.” The term “finishing agent” is herein used to refer to any additive, coating, or colorant that may be added to non-woven fabric. While the discussion herein addresses an air-laid system for Spunlace production, the principles of the present invention may be equally applied to wet-laid process, and any non-woven bonding process, such as, but not limited to, chemical bonding, and all forms of hydro-entanglement. It should be noted that it has been found that applying a finishing agent while the non-woven fabric in still wet avoids the creation of dust that may clog the application equipment. Further, some of the dust may contain particles of finishing agent that may collect on the transfer roll thereby possibly introducing finishing agent in undesired areas of the surface of the non-woven fabric. This advantage of applying a finishing agent to the still wet non-woven fabric is particularly true when the finishing agent is a selectively applied colorant applied as a pattern or graphic design. It is a further advantage that wetness of the fabric helps to reduce frictional heating and evaporation of the water helps to cool some of the mechanical parts which comes in contact with the wet fabric. The present invention also addresses the issue of energy efficiency by eliminating the now unnecessary extra heating required by the batch printing and finishing agent application system of prior art.

It should be noted here, that by way of the final drying process the fabric and thus the additives may be rendered dry, for dry use or so as to be re-constituted during final packaging or by the end user prior to use. Further, as mentioned elsewhere, a number of additives/finishing agents may be added in combination during the production run of the non-woven fabric according to the teachings of the present invention. The resulting product, therefore, may be any substantially dry product formed from non-woven fabric impregnated, coated, and/or printed with a finishing agent or combination of finishing agents. This product may then be used to produce any wet, damp or dry consumer product, such as, but not limited to, wet or damp hygienic/personal cleaning wipes (baby wipes) onto which a graphic design has been printed and lotion has been applied. Other non-limiting examples of consumer products to which the present invention may be used to advantage may include:
Applicator towelettes to which disinfectant, a sunscreen/blocking agent, lotion, scent, deodorant, antiperspirant, facial or skin treatment, cleansing, and/or lubricating agents have been added.
Industrial cleaning clothes, mop heads, to which detergent and/or disinfectant has been added.
Dusting or polishing clothes to which dust trapping and/or polishing agents have been added.
Table covers and placemats to which a pattern or graphic design has been added.
Imitation “steel wool” configured form non-woven fabric to which an abrasive agent has been added.
Sanitary accessories to which a softening agent has been added.
Any cloth material with fire retardant properties, such as, but not limited to, a Baby blanket/layette children's nightwear and wall covering material.

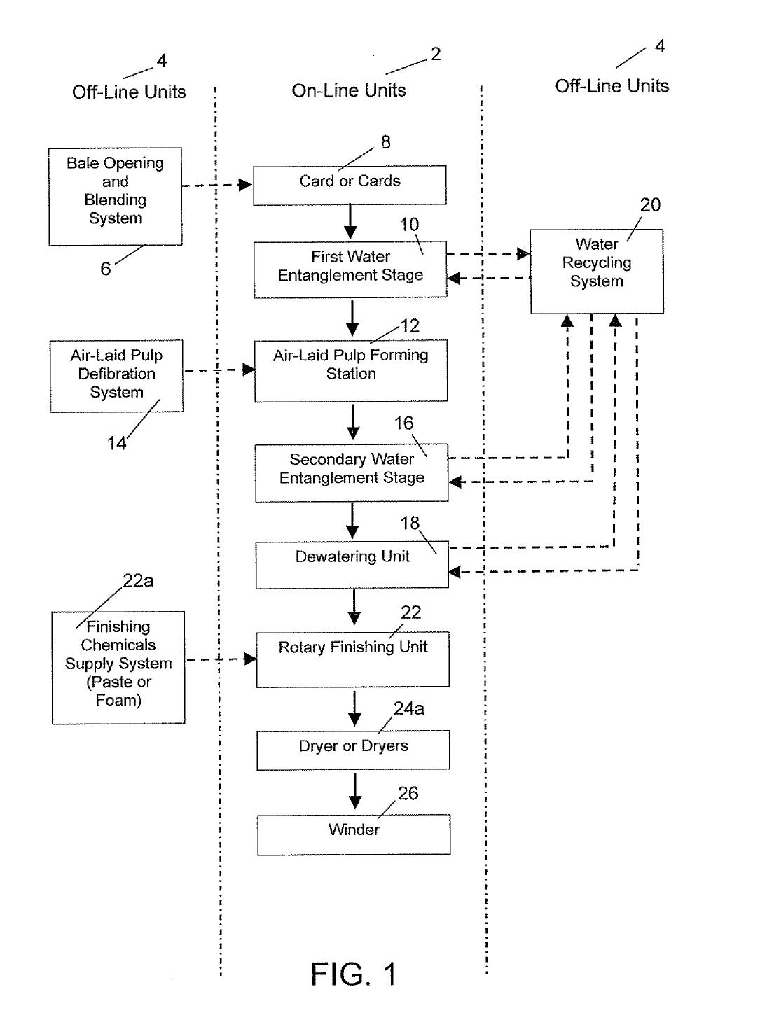

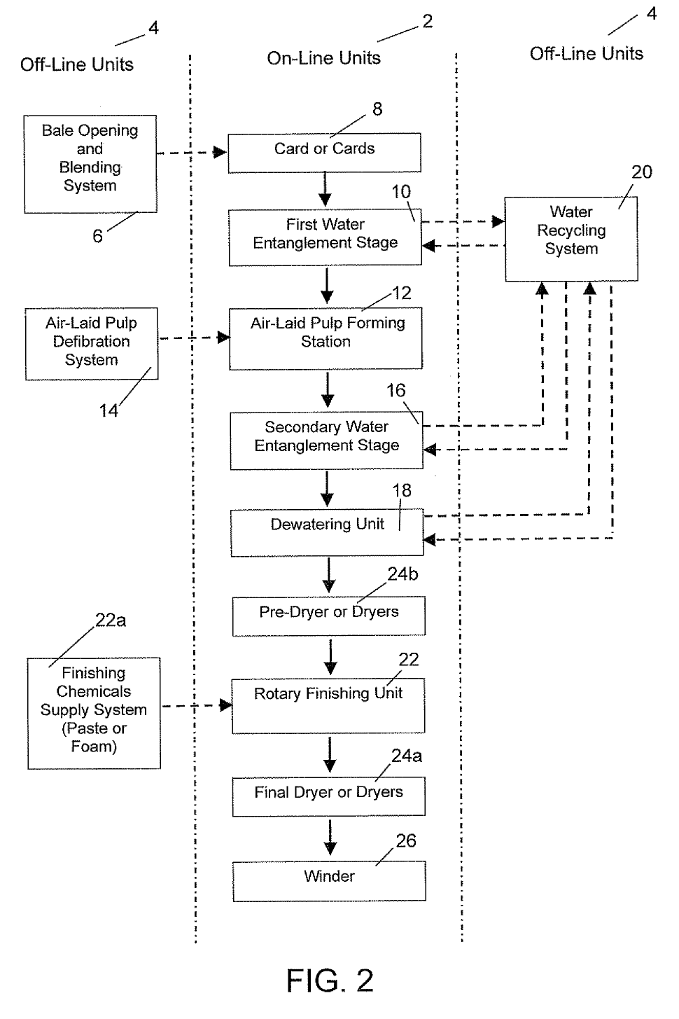

Referring now to the drawings, FIGS. 1 and 2 illustrates, in block form, the on-line 2 and off-line 4 elements of a preferred embodiment of a production line for the production of spunlace non-woven fabric constructed and operative according to the principles of the present invention. FIGS. 1 and 2 include many of the same elements and therefore corresponding elements are similarly numbered, and the following discussion is directed to both Figures expect where individual Figures are explicitly referenced. The bales of raw material are first “opened” (pre-processed) and blended 6. The raw material is then carded 8 and the resulting fibers are then feed into a hopper leading to the first water entanglement stage 10. The now partially formed web passes through the air-laid forming station 12, which may include an off-line defibration system 14. The web undergoes a second water entanglement stage 16, and at this point, the non-woven web is substantially fully formed with a water-to-fibers weight ratio of about 10:1 (i.e. 1000%). That is, when referring to the relation of water to fibers as a percentage, the value is derived by dividing the weight of the water by the weight of the fibers and multiplying that number by 100. The dewatering unit 18 preferably, but not limited to, a vacuum dewatering system, brings the water-to-fibers weight ratio down to about 0.8-1.5:1 (i.e. 80%-150%). Alternative dewatering units may include, but are not limited to, squeeze roller systems. Due to the large amount of water required by the water entanglement process an off-line water recycling system 20 in used.

An innovation of the present invention is to apply a finishing agent to the still wet, damp or moist non-woven fabric in the production line before the fabric enters the final drying unit 24a. The finishing unit 22 is preferably, but not limited to, a rotary screen printer such as, but not limited to, a Stork® CFT. The physical form (e.g. consistency) in which the finishing agent is supplied to the application apparatus determines the apparatus that is used for its application. In the case of the preferred embodiment discussed herein, using a Stork® CFT application apparatus, the finishing agent is supplied from the finishing chemicals supply system 22a (e.g. pump or foamer) in the physical form of either a paste or a foam. Alternately, an engraving roll printing system may be used.

In the embodiment of FIG. 1, the non-woven fabric enters the rotary finishing unit 22 with a water-to-fibers weight ratio of about 0.8-1.5:1 (i.e. 80%-150%) as mention above. Due to variances in the characteristics of different web fibers, thickness of the finished non-woven fabric, and the various finishing agents that may be applied, it may be advantageous to reduce to the water content of the non-woven fabric before applying the finishing agent. To that end, the alternative production line of FIG. 2 provides-a pre-dryer to reduce the weight ratio of water to fiber to an amount less than 0.8:1 (i.e. <80%) with 0.1:1 (i.e. 10%) being the preferred minimum moisture content when the additive is applied.

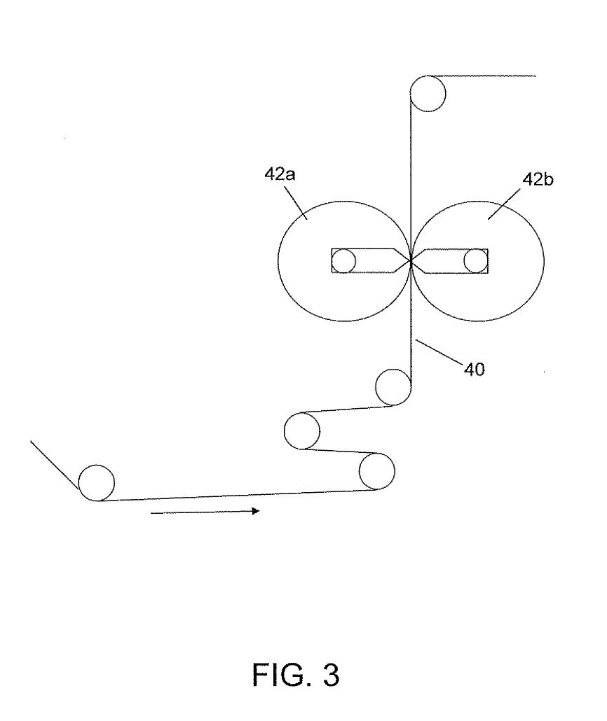

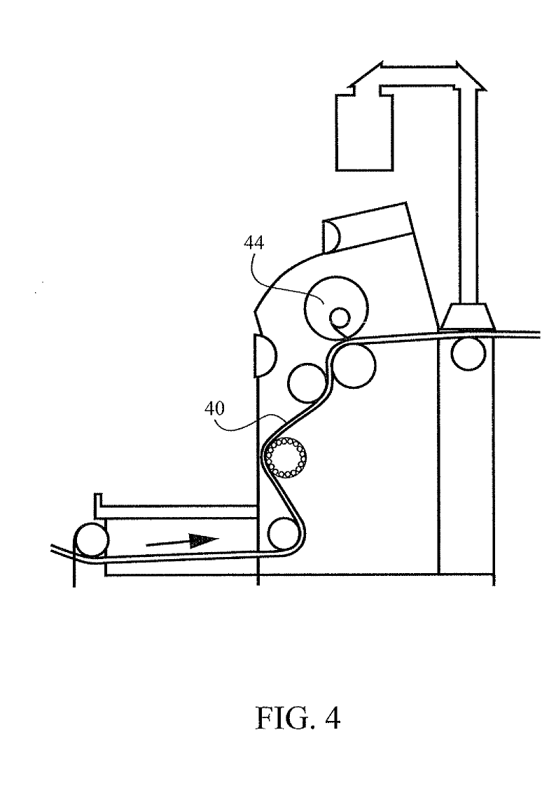

The finishing agent may be applied to both sides of the non-woven fabric 40 by two rotary screen printers 42a and 42b, as illustrated in FIG. 3. It should be noted that rotary screen printer 42a may apply one finishing agent, such as, but not limited to, a colorant selectively applied as a graphic design, such as, by non-limiting example, a logo, while rotary screen printer 42b applies a different finishing agent, such as, but not limited to, a scented body lotion. Alternatively, the finishing agent may be applied to only one side of the non-woven fabric 40, as illustrated in FIG. 4, using a rotary screen printing device with a single applicator 44. It will be appreciated that a number of rotary screen printers may be arranged so as to provide for the application of the number of finishing agents required for a particular product.

It will be appreciated that there is a wide range of additives and application characteristics that are suitable for application using the principles of the present invention. Application characteristics may include, but not be limited to, viscosity of the additive, distribution and/or penetration of the additive through the thickness of the fabric, absorption of the additive into the fibers, coating of the fibers, and filling the voids between fibers with additive. When adding color to the fabric a uniform half-tone dot pattern of colorant may be applied to the surface of the fabric thereby achieving a substantially uniform colored visual effect while economizing on colorant. This will also be true of any other additive which may require uniform application to the entire surface area, or regions of the surface, of the fabric while not requiring 100% coverage. Such additives may include, but not be limited to, detergents, lotions, scents, disinfectants, and skin treatments compositions.

It will be appreciated that the above descriptions are intended only to serve as examples and that many other embodiments are possible within the spirit and the scope of the present invention.

What is claimed is:

1. A system for applying a finishing agent to non-woven fabric during production of the non-woven fabric, the system comprising:
(a) a web forming apparatus configured to form a substantially continuous web of non-woven fabric;
(b) a finishing apparatus configured to apply the finishing agent to the non-woven web fabric as an in-line process in the production; and
(c) at least a first drying apparatus configured to dry said non-woven fabric together with said finishing agent.

2. The system of claim 1, wherein said web formation apparatus is a hydro-entanglement apparatus.

3. The system of claim 1, wherein said web formation apparatus is a wet-laid web formation apparatus.

4. The system of claim 1, wherein said web formation apparatus is a dry-laid web formation apparatus.

5. The system of claim 1, further comprising a dewatering apparatus configured to remove of at least a portion of production water from said non-woven fabric.

6. The system of claim 5, wherein said dewatering apparatus renders water content of said non-woven fabric greater than 10% by weight.

7. The system of claim 5, wherein said dewatering apparatus renders water content of said non-woven fabric 80%-150% by weight.

8. The system of claim 5, further including at least a second drying system deployed between said dewatering apparatus and said finishing apparatus.

9. The system of claim 8, wherein water content of said non-woven fabric is 10%-80% by weight.

10. The system of claim 1, wherein said applying of the finishing agent is substantially uninterrupted along said substantially continuous non-woven fabric.

11. The system of claim 1, wherein said finishing apparatus is a rotary finishing application system.

12. The system of claim 11, wherein said rotary finishing application system is a rotary screen printing system.

13. The system of claim 11, wherein said rotary finishing application system is an engraving roll printing system

14. The system of claim 11, wherein rotary finishing application system is configured so as to apply a paste.

15. The system of claim 11, wherein rotary finishing application system is configured so as to apply a foam.

16. The system of claim 1, wherein said finishing agent includes a detergent additive.

17. The system of claim 1, wherein said finishing agent includes a scent producing additive.

18. The system of claim 1, wherein finishing apparatus is configured so as to selectively apply a colorant.

19. The system of claim 18, wherein said colorant is selectively applied as a graphic design.
